(19) United States
(12) Patent Application Publication
(10) Pub. No.: US 2002/0082887 A1
(43) Pub. Date: Jun. 27, 2002

(54) Distribution system and method

(76) Inventors: Ross J. Boyert, Atherton, CA (US); Kristen K. Boyert, Atherton, CA (US)

Correspondence Address: GARY CARY WARE & FREIDENRICH, 1755 EMBARCADERO, PALO ALTO, CA, 94303-3340, US

(21) Appl. No.: 09/992,352

(22) Filed: Nov. 13, 2001

Related U.S. Application Data
(60) Provisional application No. 60/257,858, filed on Dec. 22, 2000.

(51) Int. Cl. G06F 17/60

(52) U.S. Cl. 705/7

(57) ABSTRACT

A distribution system provides a ordering system that receives electronic orders and provides order information to corresponding warehouses or suppliers. The goods are supplied to a delivery system that transports the goods to one of the predetermined delivery points for pickup by the user. The pre-determined delivery points are arranged with an entity associated with the location of the delivery point, and are selected based on buying characteristics of the people near the site.

### BACKGROUND OF THE INVENTION

This invention relates to the distribution of goods to consumers, and more particularly to an order and purchase system, a goods processing system, and a delivery system through which goods can be purchased by and delivered to consumers.

It is known to display goods on a website and to permit consumers to purchase such goods for delivery by conventional means-mail or other delivery services. An example is Amazon.com from which books can be purchased from the website, usually paid for by credit card or by other means, and then shipped to the purchaser. Another example is a retail grocery service, combining Internet purchases of groceries with a home delivery service that transports the purchases to the purchaser's door.

### SUMMARY OF THE INVENTION

The invention provides a distribution system which provides the convenience of fast personalized distribution to customers at a cost below true home delivery.

The present invention resides in an improved distribution system, which may utilize Internet display of goods for purchase, and ordering and payment, with delivery to pre-selected collective delivery points by dedicated delivery vehicles for convenient pick-up by the purchaser. The present invention may provide the pre-arrangement of the collective delivery points at locations that are accessible and convenient to a particular group of customers, such as employees of a particular company or organization, or residents of an identifiable community, and the promotion of the service to that company or community in a manner that enables the customers to accomplish the pick-up of the purchased goods as an incident to an unrelated activity, such as departing from work.

The present invention provides a distribution system and method that establishes an interface, portal or website for the selection and ordering of goods; establishes at least one selected collective delivery point that is convenient for a particular group of prospective purchasers; takes orders from members of the group of purchasers for delivery to the delivery site during a pre-arranged time period; and delivers the orders by dedicated delivery mechanism to the delivery site for pick up by the customers during the pre-arranged time period. A plurality of selected delivery points may be established by pre-arrangement with a plurality of companies and organizations having numerous members and employees. The dedicated delivery mechanism may be trucks. The goods may be groceries.

The present invention may provide a distribution method that receives orders from ones of a group of purchasers for delivery to a delivery site associated with said group of purchasers during a pre-arranged time period associated with said group of purchasers; and transports goods associated with said orders to said delivery site for pick-up by said ones of said group of purchasers. The orders may be received via the Internet. The transporting of goods may be by dedicated delivery vehicles. The pick-up may be during a time period that is prearranged relative to the delivery site and not pre-arranged by ones of the group of purchasers.

The present invention provides a site selection method that comprises analyzing the number of people that transit a target location during a time period; analyzing purchasing characteristics of said people relative to a class of goods; and selecting the target location as a delivery site in the event that said number of people exceeds a predetermined threshold and said purchasing characteristics collectively meet a predetermined threshold.

The present invention provides site selection comprising selecting a group of persons having a common characteristic associated with a region during a time interval; establishing at least one selected delivery point in said region; and receiving orders for goods from ones of said group of persons for delivery to the delivery site for pickup by said ones of said group of persons during a pre-arranged time period of said time interval.

### BRIEF DESCRIPTION OF THE DRAWINGS

FIG. 1 is a block diagram illustrating a distribution system according to the present invention.

FIG. 2 is a block diagram illustrating an order center of the distribution system of FIG. 1 according to the present invention.

FIG. 3 is a diagram illustrating an order screen of a virtual retail outlet for the order center of FIG. 2 according to the present invention.

FIG. 4 is a block diagram illustrating a goods processing system and a delivery system of the distribution system of FIG. 1 according to the present invention.

FIGS. 5a and 5b are side and rear exterior views, respectively, of a transport vehicle of the distribution system of FIG. 1 according to the present invention.

FIGS. 6a and 6b are side and rear interior views, respectively, of the transport vehicle of FIGS. 5a and 5b according to the present invention.

FIG. 7 is a top view of a delivery site of the distribution system of FIG. 1 according to one embodiment of the present invention.

FIG. 8 is a block diagram illustrating a distribution system including a secondary delivery system according to another embodiment of the present invention.

FIG. 9 is a block diagram illustrating a distribution system including a goods aggregation system according to another embodiment of the present invention.

FIG. 10 is a flow diagram illustrating a method of forming a delivery system and delivery network according to the present invention.

### DETAILED DESCRIPTION

Other aspects and advantages of the invention will be apparent from the following detailed description. It is to be understood that the invention is applicable to goods of various kinds, and that the invention builds a broad platform for retail sales via the Internet, while providing a very convenient base or bases for actual contact with the purchaser, thus providing for returns and customer service and the like in a convenient direct manner not presently available in conventional Internet transactions.

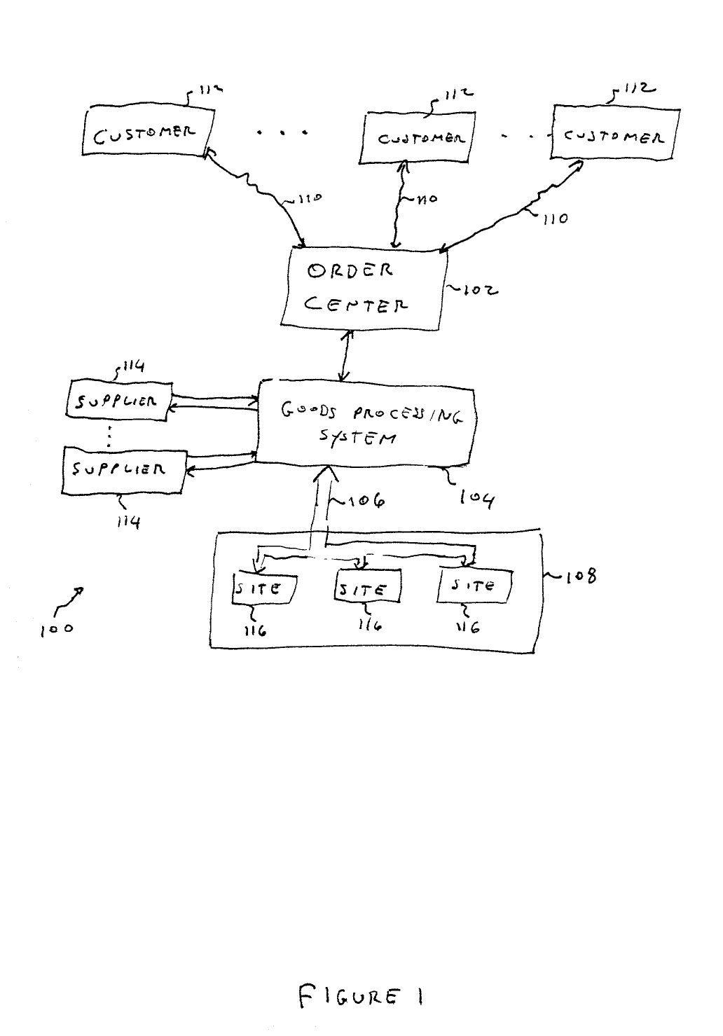

FIG. 1 is a block diagram illustrating a distribution system 100 in accordance with the present invention. The distribution system 100 comprises an order center 102, a goods processing system 104, a delivery system 106, a delivery point network 108, and a communication system 110.

A customer 112 places an order for goods via the communication system 110 with the order center 102 and establishes a payment process for the order. The communication system 110 may include, for example, mail delivery, the Internet, a public switched telephone system, a wireless system, a fiber optic system, a laser system, an electronic system, or cable, satellite or broadcast television systems that may or may not be interactive. The payment process may be, for example, payment with the order (e.g., credit card, debit card, or credit line) or at the delivery point network 108 when the goods are received.

In one embodiment, the customer 112 includes a person that interfaces directly with the communication system 110. For example, a customer 112 uses a telephone to communicate with the communication system 110. In other embodiment, the customer 112 includes a person and a communication interface, such as a computer with a web browser or an Internet appliance. In yet another embodiment, the customer 112 does not include a person that directly places an order. For example, the customer 112 may include an appliance, such as a refrigerator, that monitors the environment therein, such as the contents, such as milk, eggs, or butter. In the event that the quantity of the monitored contents is below a threshold, the appliance automatically places an order for the item with the order center 102 via the Internet or telephone. The appliance or the order center 102 may inform a person associated with the appliance that the order is placed and will be available for pick up.

The order center 102 provides goods information including price and availability to the customer 112, processes the order, and provides order information to the goods processing system 104. The order center 102 processes the payment or arrangement for payment for the orders.

The goods processing system 104 receives goods from suppliers 114 and stores or processes the goods for sale. In one embodiment, the goods processing system 104 comprises a centralized warehouse. In another embodiment, the goods processing system 104 comprises a plurality of warehouses of which some or all may be centralized in various locations. The delivery system 106 transports and distributes the goods to the delivery point network 108. The delivery system 106 may include, for example, transport vehicles 408. (See FIG. 4.) Ordered goods are pre-packaged, sorted, and assigned to and loaded on the transport vehicles 408 at the goods processing system 104 for delivery to pre-selected delivery sites. Returns are delivered back to the goods processing system 104 for processing and/or resale. A supplier 114 may be a legal entity that is related to, separate from or non-related to the order center 102 or the goods processing system 104. A supplier 114 may be physically located near the goods processing system 104 or in a distant location.

In one embodiment, the goods processing system 104 orders from the suppliers 114 the goods that are ordered by the customer 112, after receipt of the customer order, and maintains no inventory other than goods ordered within a time period, such as the delivery day and the time after the order cutoff time of the previous day. In such an embodiment, the goods processing system 104 maintains an inventory of only the goods ordered that are physically being processed or transported for the customer orders. In another embodiment, the goods processing system 104 may include an inventory of popular items, high margin items, or perishable and non-perishable items.

The delivery point network 108 comprises at least one delivery site 116. The delivery site 116 is a location where the goods may be picked up or received by the customer 112. The delivery site 116 may be, for example, a related group site, a convenience site, or a fixed site. A related group site is a location at which a group of people associate for reasons unrelated to the ordering and/or receipt of goods. The related group site may be, for example, a place of employment, a church, or an educational institution. In one embodiment, the delivery sites 116 are predetermined based on anticipated customer convenience.

The distribution system 100 may provide a distribution channel for goods returned from the customer 112. In one embodiment, the customer 112 may return goods at the delivery site 116. In one embodiment, each delivery site 116 may also accommodate customer returns, which are transported back to the goods processing system 104 for re-sale or return to the supplier 114.

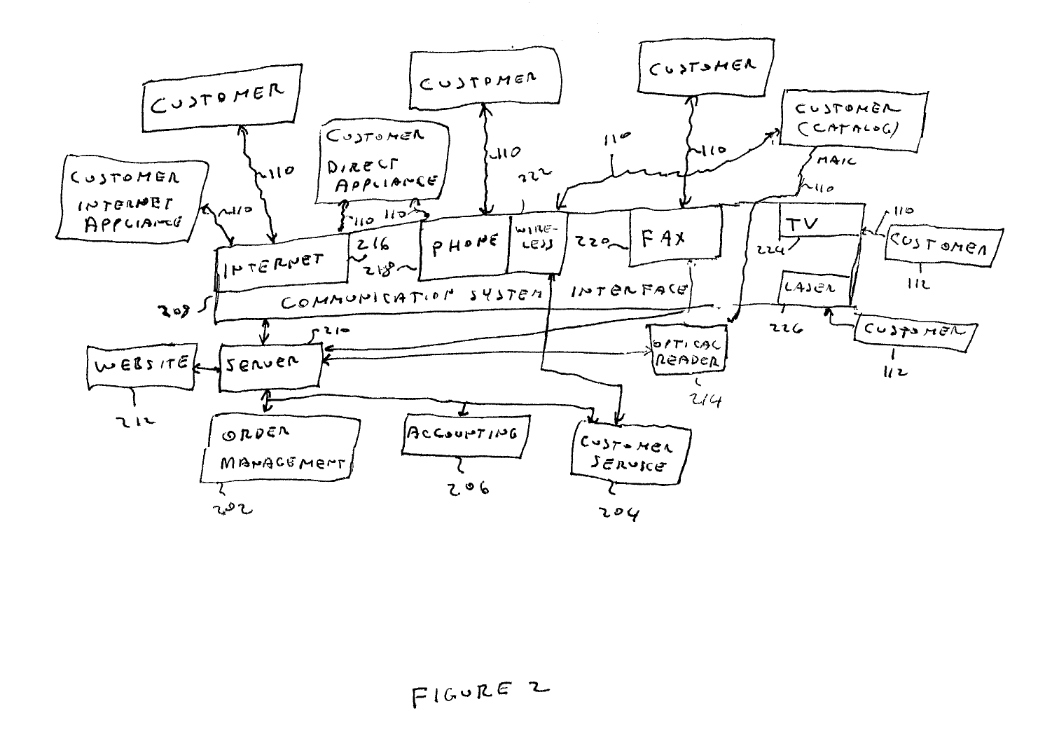

FIG. 2 is a block diagram illustrating the order center 102 in accordance with the present invention. The order center 102 may comprise an order management system 202, a customer service system 204, an accounting system 206, a communication system interface 208, a server 210, a website manager 212, and an optical reader 214. The communication system interface 208 comprises an Internet interface 216, a telephone interface 218, a facsimile (fax) interface 220, a wireless interface 222, a television interface 224, and a laser interface 226.

The order management system 202 communicates through the communication system interface 208 with the customer 112 via the communication system 110. The order management system 202 provides information related to goods available for purchase via the communication system interface 208 through the communication system 110 to the customer 112. The customer 112 places an order through the communication system 110 and the communication system interface 208 to the order management system 202. The order management system 202 processes the order and provides order information to the goods processing system 104. The order management system 202 provides financial information related to the order to the accounting system 206.

The customers 112 place their orders through the order center 102. Goods may be ordered, for example, via the Internet, telephone, television, wireless, laser, catalog and electronically, using the corresponding interface 216, 218, 20, 222, 224, and 226. In one embodiment, goods ordered by a specified time (e.g., 10:00 a.m.) are packaged and delivered to a specified delivery site 116 (e.g., at the place of business of the customers' employer) at a specified time (e.g., between 4:00 and 7:00 P.M.).

For a customer 112 that orders via the Internet, the customer 112 communicates with the order center 102 via a communication system 110 that includes an Internet portal. The server 210 communicates via the Internet interface 216 of the communication system interface 208 with the customer 112. The website manager 212 controls the website information presented to the customer 112. The server 210 and the website manager 212 may be physically located near or separated from the other systems of the order center 102. In another embodiment, the Internet functions of the server 210 may be part of an Internet service provider (ISP). In another embodiment, the website manager 212 may be hosted by the ISP.

Using the Internet or interactive television, the customer 112 accesses the order center 102 through a common connection, web site and/or portal. The Internet web site and/or portal allows the customer 112 to order and pay on-line. In one embodiment, the web site allows the customer 112 to visually peruse the items for sale which are on display in a “cyber-store” which looks similar to a conventional “bricks and sticks” retail store layout. The “cyber-store” may be presented in a customer friendly video, digital and/or pictorial format. In one embodiment, a customer 112 wishing to purchase groceries may see a virtual retail outlet, such as a visual layout of a typical supermarket, with shelves stocked with items for purchase. For interactive television, the customer 112 views items for sale through the broadcast, cable, or satellite connection, and places their order, and may or may not pay on-line.

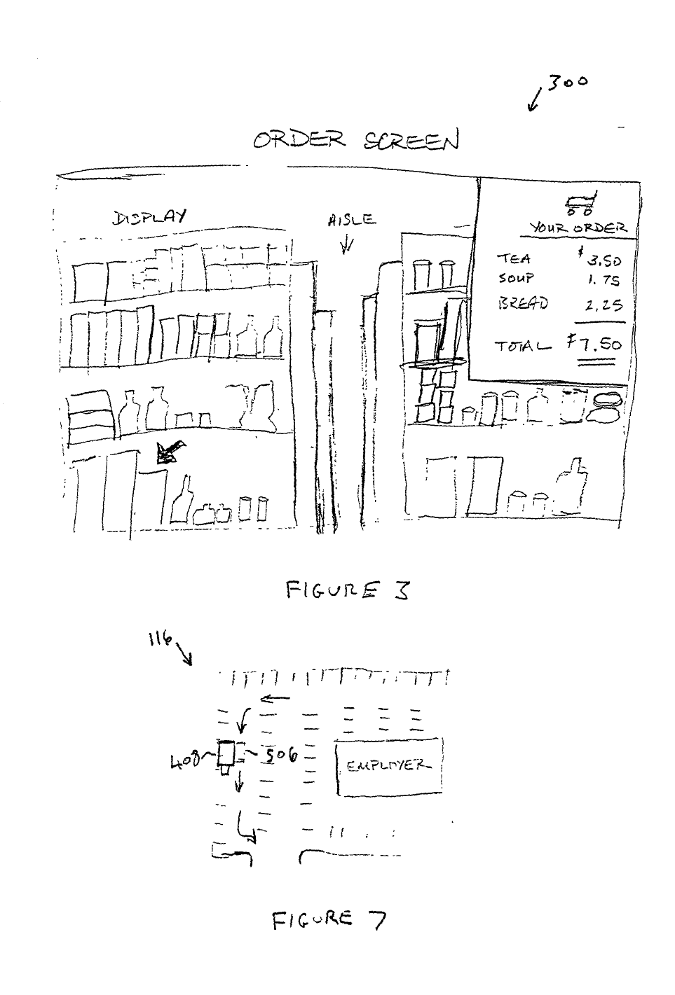

FIG. 3 is a diagram illustrating an order screen 300 of a virtual retail outlet according to the present invention. For example, the order screen 300 may be provided to the customer 112 using the Internet or interactive television. The order center 102 provides the order screen 300 to the customer 112. The order screen 300 provides a graphical user interface for interactive communication with the customer 112 to provide information regarding goods available for ordering from the order center 102 and to send an order from the customer 112 to the order center 102. Perusing the aisles for selected items, the customer 112 may see visual representations of items for sale and their corresponding prices. A single click on selected items adds the product to an electronic “shopping cart” of the customer 112. Electronic “shopping carts” are well known in the art. An itemized list and running total of goods purchased is displayed in a separate section of the order screen 300.

On the order screen 300, a selection action, such as a “double click” or “right click” of a user cursor control device, brings up additional details on the product including advertising, product specifications, and warranties. To remove any items from an order, the customer 112 clicks on the item to be removed from the electronic shopping cart. To confirm an order, the customer 112 clicks on the total amount included in the electronic shopping cart. The order is then electronically routed from the order center 102 to the goods processing system 104 for processing and goods delivery.

Upon completing the order via the click on the shopping cart total, the order center 102 provides the customer 112 with an order identification number (or use their own name) for presentation at the delivery site 116. For interactive television, confirmation of the customer order is confirmed with an order identification number (or use their own name) for presentation at the delivery site 116. The customer 112 may print out his order number, or if lost, his credit card, which is presented to the delivery site attendant who in turn loads the items into the customer's car. Orders can be paid for either on-line or at the delivery site. Alternatively, the customer 112 may have a smart card programmed to indicate a customer number, an order identification number or other identifier to identify the customer 112 or the order.

Refer again to FIG. 2. For a customer 112 that orders by catalog or television, the customer 112 may either mail or phone orders directly to the order center 102. The communication system 110 includes a telephone connection and a mail delivery. The telephone interface 218 of the communication system interface 208 communicates with the customer 112 via the communication system 110. The customer 112 receives goods and order information from a catalog provided by a goods provider. Additional information may be provided to the customer 112 by the customer service system 204 in response to telephone or mail inquiries. The customer service system 204 may be fully automated, or partially automated with interaction between a person at the customer service system 204 and the customer 112. Mail orders are scanned and read by the optical reader 214 and processed by the server 210 and the order management system 202.

The customer service system 204 may be maintained to help customers 112 with their Internet, telephone, television, wireless, laser, electronic, or mail orders. Phone assistance may be rendered as necessary to assist customers 112 in their use of the system.

For a customer 112 that orders by telephone, the customer 112 phones the order center 102 via the telephone interface 218. A person at the order center 102 may take the order or the server 210 may be programmed to provide automated ordering.

For a customer 112 that orders by facsimile, the customer 112 faxes the order via the communication system 110 and the facsimile interface 220 to the server 210 for processing by the order management system 202.

FIG. 4 is a block diagram illustrating the goods processing system 104 and the distribution system 106 according to the present invention. The goods processing system 104 comprises at least one goods processing center 400. In one embodiment, the goods processing system 104 comprises a centralized warehouse. The goods processing center 400 comprises a goods tracking management system 402, an inventory management system 404, a return management system 406, and a goods allocation system 404. The delivery system 106 comprises at least one transport vehicle 408.

The goods processing system 104 receives goods from the suppliers 114 and stores the goods for sale. The order center 102 electronically sends the orders of the customers 112 to the goods processing system 104. Ordered goods are assembled, pre-packaged, sorted and loaded on the transport vehicles 408 for delivery to the pre-selected delivery site(s) (delivery sites 116). In response to an order, which includes order information and delivery destination information, the goods tracking management system 402 searches the inventory management system 404, which may include an inventory database, for the availability of goods and generates a stock request for each of the available ordered goods. The goods tracking management system 402 may send an order to the suppliers 114 for the ordered goods. For each order, the ordered goods are assembled and pre-packaged. The goods allocation system 407 sorts the pre-packaged ordered goods by delivery destination (delivery site 116) and groups them based on common delivery sites 116. The goods allocation system 407 assigns the groups of packaged goods to the transport vehicles 408 according to the delivery sites 116. The grouped packages are provided to the delivery system 106 and loaded on the transport vehicles 408 for delivery to the pre-selected delivery sites 116.

In one embodiment, one or more of the transport vehicles 408 are dedicated to corresponding ones of the delivery sites 116. For example, a transport vehicle 408 that is a large vehicle is dedicated to delivery to a delivery site 116 that is a large place of employment, and another transport vehicle 408 that is a smaller vehicle, such as a van, is dedicated to a delivery site 116 that is a small place of employment.

Customer returns are delivered to the goods processing system 104 for resale or other processing such as a return to the supplier 114. In one embodiment, the return management system 406 informs the goods tracking management system 402 and the inventory management system 404 to account for the return items returned to stock and modifies a return database for accounting, quality control, and the like.

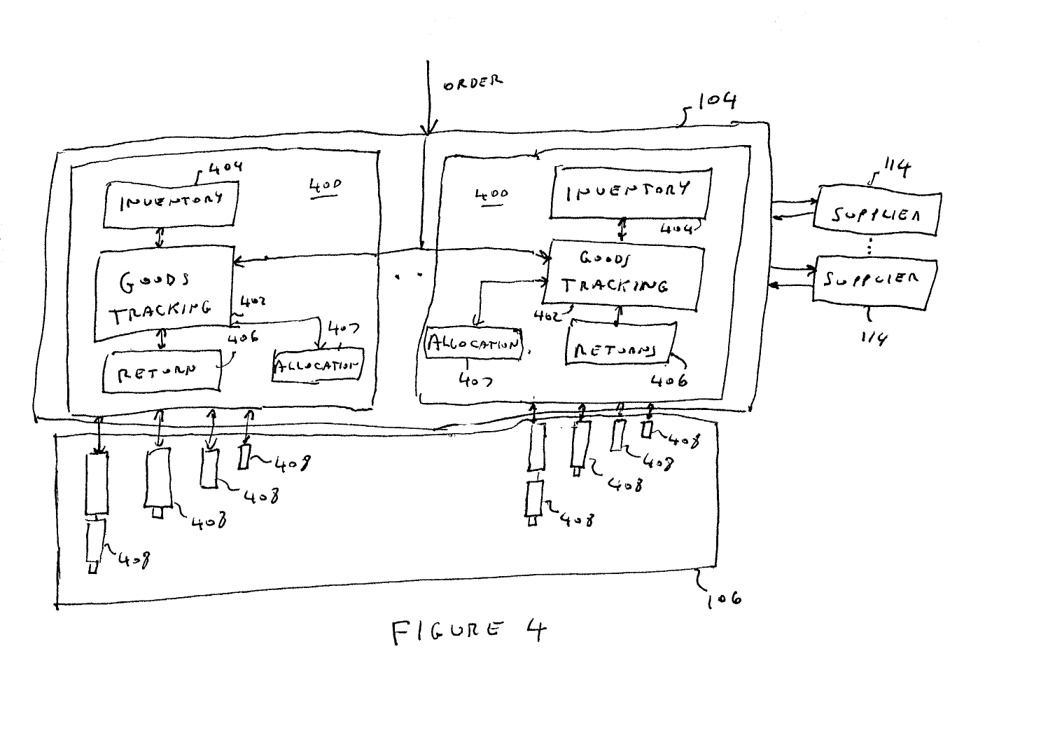

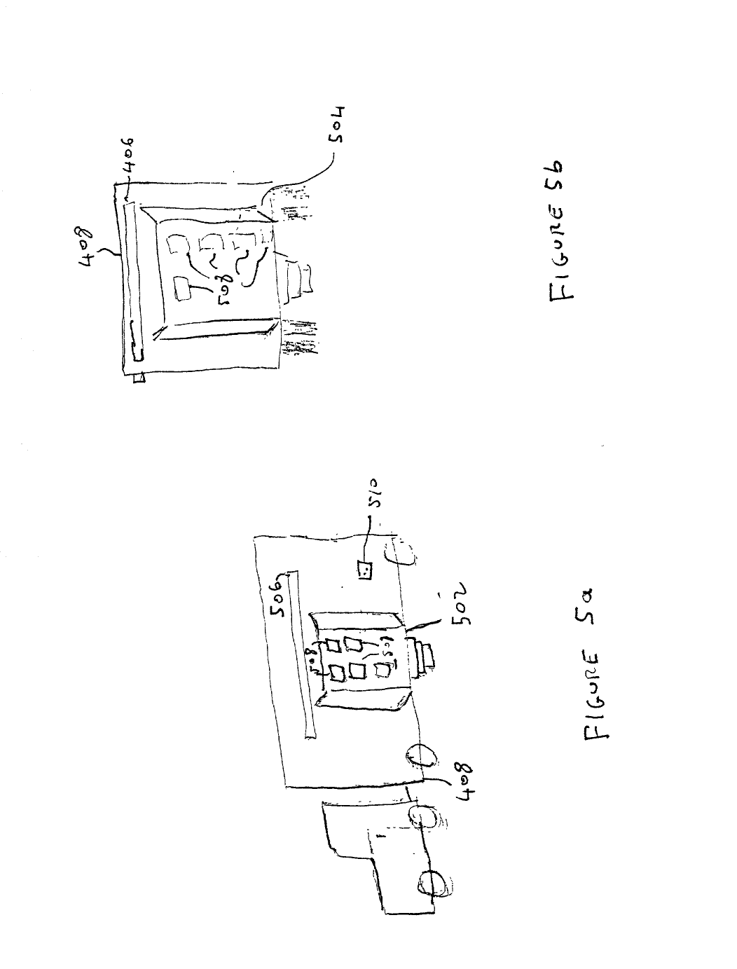

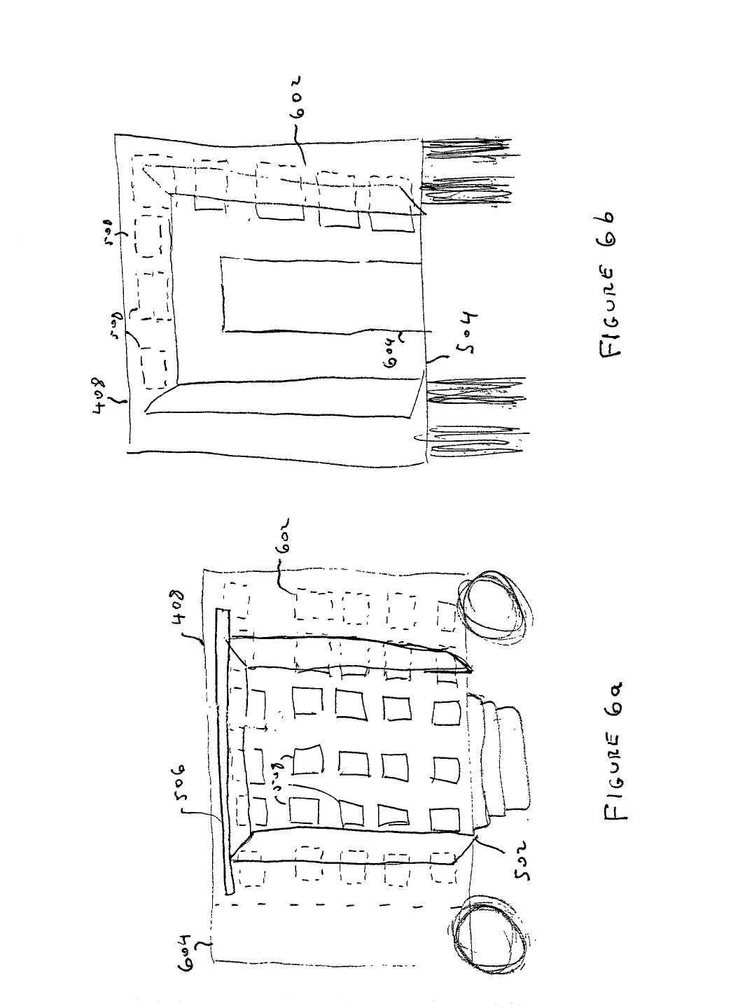

FIGS. 5a and 5b are side and rear exterior views, respectively, of the transport vehicle 408. FIGS. 6a and 6b are side and rear interior views, respectively, of the transport vehicle 408.

The transport vehicles 408 may comprise a number of configurations, which can be scaled to match the quantity and size of goods to be delivered to each delivery site 116. The transport vehicles 408 may include 18 wheel semi-truck trailers (with single or double trailers), mid-size, and vans.

In one embodiment, the exterior configuration of the transport vehicles 408 may include a side access 502 and a rear access 504 to the interior and thereby to the merchandise. This allows for flexibility in parking the transport vehicle 408 to provide the customer 112 a more convenient way to pick-up their ordered packaged goods 508. In one embodiment, the transport vehicles 408 include an exterior appearance resembling a permanent “bricks and sticks” structure, such as a country store facade or other contemporary retail designs. In one embodiment, dedicated transport vehicles 408 may include an exterior that includes a logo associated with the delivery site 116. For example, for a delivery site 116 that is a place of employment, the dedicated transport vehicle 408 includes the logo of the employer.

The transport vehicle 408 may include an awning 506 to cover the customer 112 during the receipt of the packaged goods 508 and an order system interface 510 for the ordering of goods.

The transport vehicle 408 may include storage racks 602 for storing the packaged goods 508. At the goods processing center 400, merchandise is placed in numbered storage racks 602. The storage racks 602 may be fixed or movable. In one embodiment, the movable storage racks 602 may be similar to those commonly found in the dry cleaning business whereby a customer name/order number is input and the rack moves until the customer order is positioned for retrieval by the delivery service employee for delivery to the customer. The transport vehicle 408 may include a cold temperature storage unit 604 for storing goods that need refrigeration. The cold temperature storage unit 604 may include a refrigerator or a freezer or both.

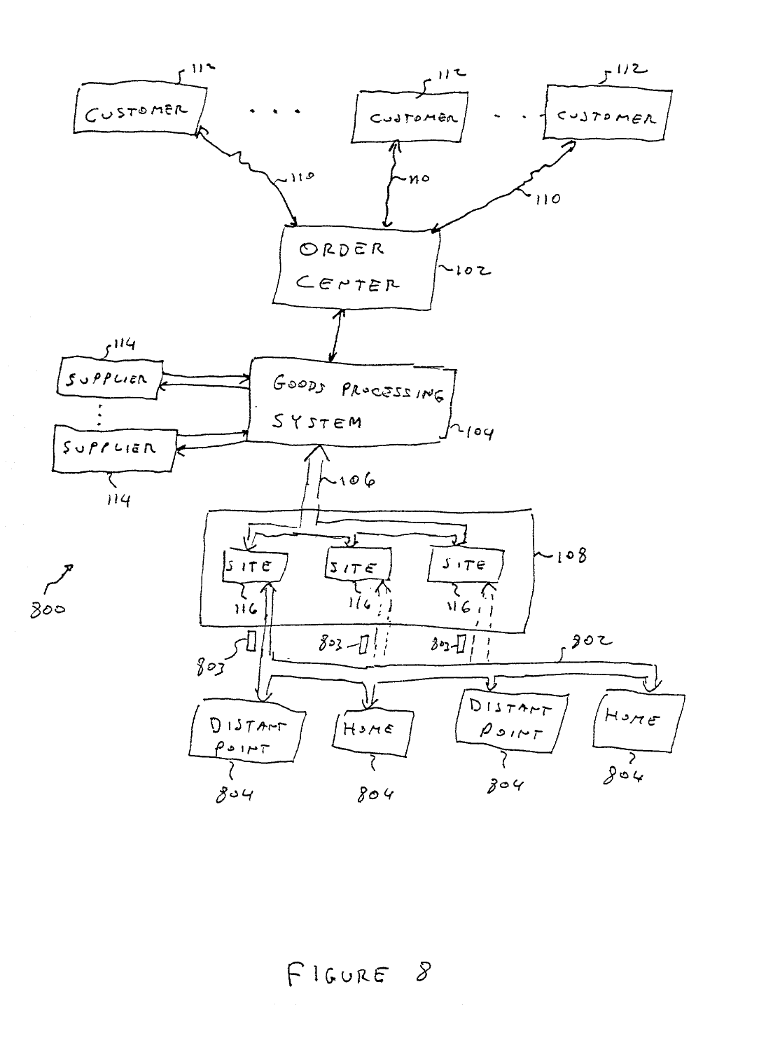

FIG. 7 is a top view of a delivery site 116. As noted above, the delivery site 116 may be a place of employment. The transport vehicle 408 may be parked in a convenient location on or near the premises, such as in a parking area or garage. The transport vehicle 408 may arrive daily at an agreed time and remain on-site for an agreed time period. For example, the transport vehicle 408 may arrive at 4:00 P.M. and remain on-site until 7:00 P.M. The customer 112 drives (or walks) to the transport vehicle 408 by following, for example, a path designated by delivery service personnel and/or orange directional cones. The customer 112 drives up to the vehicle-loading zone, which may be identified and protected by the covered awning 506. Upon reaching the loading zone, the customer 112 provides their order identification to the delivery service personnel whom, in turn, loads the ordered items into the car of the customer 112 for the trip home. The delivery service personnel may collect payment of non-prepaid items at that time. Merchandise returns may also be accepted by the transport vehicle 408 during the hours it is on-site at the employee site and returned to the goods processing system 104 for processing. Orders may also be placed during these hours utilizing the order system interface 510.

As noted above, the delivery site 116 may be a convenience site. The transport vehicle 408 may be parked at a convenient site near high traffic or high density locations. These convenience sites may be, for example, areas around apartments, condominiums, mass transit entrances, commuter parking lots, parks, sports facilities and the like. The system's flexibility allows a transport vehicle 408 to be located where there are large pools of people that are easily accessible. Locations may be on public or private land.

The transport vehicle 408 may arrive daily at an appointed time remaining on site for a specified period. For instance, the transport vehicle 408 may arrive at 4:00 P.M. and depart at 7:00 P.M. The customers 112 may drive (or walk) to the transport vehicle 408, present their order identification to the delivery service person and receive their goods (payment of non-prepaid items may be collected at that time). Merchandise returns may also be accepted by the transport vehicle 408 at the convenience site and returned to the goods processing system 104.

As noted above, the delivery site 116 may be a fixed site. Merchandise will be shipped daily to the fixed site locations and packaged to the customer's order. Hours of operation may vary from 24 hours a day to several hours only, depending upon the service requirements of each location. The customers 112 provide their order identification and receive their goods with payment due for non-prepaid items. Merchandise returns may also be accepted for return to the goods processing system 104 for processing. The customer 112 orders may also be placed at the site 116.

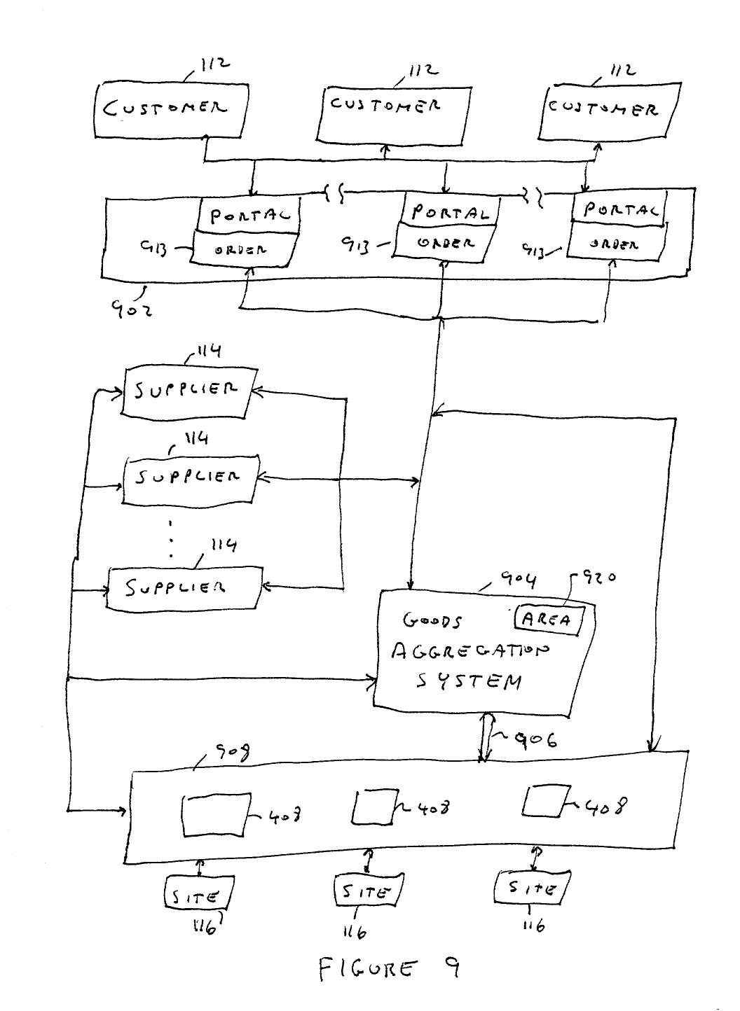

FIG. 8 is a block diagram illustrating a distribution system 800 in accordance with another embodiment of the present invention. The distribution system 800 is similar to the distribution system 100, but also comprises a secondary delivery system 802. The secondary delivery system 802 comprises secondary transport vehicles 803. The secondary delivery system 802 delivers the goods from one or more delivery sites 116 to secondary delivery sites 804. The secondary delivery sites 804 may include distant point delivery and home delivery. In one embodiment, the secondary delivery system 802 includes separate delivery sub-systems for each delivery site 116. In another embodiment, multiple delivery sites 116 may use the same delivery system. In one embodiment, each delivery site 116 provides distant point delivery and home delivery.

In one embodiment, one or more transport vehicles 408 may also be a corresponding secondary transport vehicle 803. For example, a transport vehicle 408 may deliver a portion of its cargo to a delivery site 116 and deliver, as a secondary transport vehicle 803, the remainder of its cargo to at least one secondary delivery site 804.

In one embodiment, the goods processing system 104 controls the distribution of goods in both the delivery system 106 and the secondary delivery system 802. In this embodiment, the customers 112 select delivery for pickup at a delivery site 116 or a secondary delivery site 804. The goods processing system 104 controls the allocation of the packaged goods to the transport vehicles 408 for delivery to the delivery site 116 and allocates the packaged goods to the secondary transport vehicles 803 for delivery to a secondary delivery site 804.

In another embodiment, the goods processing system 104 controls the distribution of goods in the delivery system 106, but not in the secondary delivery system 802. In this embodiment, the customers 112 select delivery to a delivery site 116 via the order center 102. One or more customers 112 may control distribution in the secondary delivery system 802 to the secondary delivery sites 804. Such customer 112 allocates the packaged goods to secondary transport vehicles 803 for delivery to a secondary delivery site 804. Such customer 112 may operate its own order center that functions similar to the order center 102, but consolidates orders from its own customers into an order or orders to the order center 102 with a delivery site 116 that are then distributed to the customers at the secondary delivery sites 804 via the secondary delivery system 802.

In another embodiment, distant point delivery allows for the shipment of ordered goods to multiple locations via a transport vehicle 408. For example, an eighteen-wheel double semi-truck configuration may be used to deliver ordered goods to one of the delivery sites 116 or one of the secondary delivery sites 804. One trailer of ordered goods of the transport vehicle 408 may be designated for the delivery site 116, while the remaining trailer may be taken to another location such as a secondary delivery site 804. In other words, goods may be segregated for delivery to multiple delivery sites 116 or 804 on one transport vehicle 408 and broken down for shipping to additional sites. The “staging” of the orders allows for the breakdown and efficient delivery of goods to additional sites from the original delivery vehicle.

Similarly, each site will have the ability to provide for home delivery. Items purchased for home delivery are segregated from the shipment to the site and organized by route. The home delivery vehicle (a transit vehicle 803) picks up the segregated goods from the delivery site 116 and then transports the items to the neighboring homes (secondary delivery site 804) on the pre-sorted route. For example, a shipment of ordered goods may be delivered to an employer site (delivery site 116) where it is met by a smaller home delivery van (secondary transit vehicle 803). The pre-ordered, pre-sorted goods are transferred to the smaller home delivery van (secondary transit vehicle 803) for transport to the customers 112 in the surrounding neighborhood.

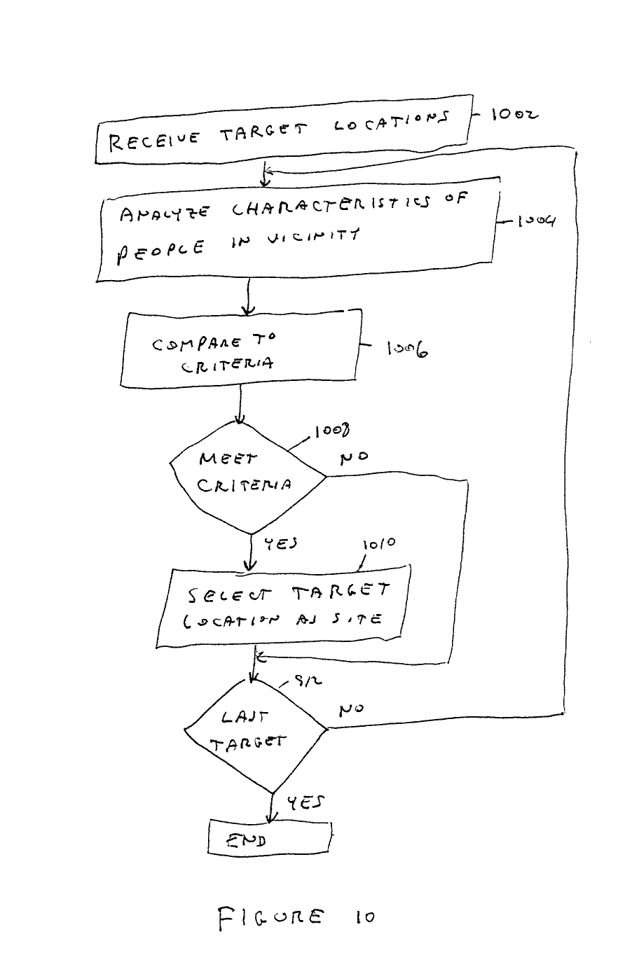

FIG. 9 is a block diagram illustrating a distribution system 900 including a goods aggregation system according to another embodiment of the present invention. The distribution center 900 comprises an order center 902, a goods aggregation system 904, a delivery system 906, a delivery point network 908, and a communication system 910. The order center 902 includes at least one order center 913, which may be similar to the order center 102. In one embodiment, a supplier 114 may operate an order center 913, or may contract for use of an order center 913. In this embodiment, the customer 112 contacts the supplier 114 directly through the communication system 910 and an order center 913. The supplier 114 routes the goods or prepositions the goods with the goods aggregation system 904. At the direction of the supplier 114, the goods aggregation system 904 arranges for the packaging and shipment of goods with the delivery system 906, such as a delivery or trucking company, for delivery to the customer 112 at a delivery site 116. The goods aggregation system 904 may be similar to the goods processing system 104 and may comprise a goods tracking management system 402, an inventory management system 404, a return management system 406, and a goods allocation system 404. The goods aggregation system 904 may receive the order information from the order center 902, the suppliers 114 or the delivery system 906 or a combination thereof. The goods aggregation system 904 combines goods from one or more suppliers 114 for each customer 112 according to the order placed. The consolidated order is then collected along with all other orders having a common delivery site 116. The shipment is then picked up for delivery by the delivery system 906. In another instance, the customer 112 contacts the delivery system 906 directly through their communication system 110. The delivery system 906 forwards the order to the goods aggregation system 904 for consolidation and pick-up. The goods aggregation system 904 maintains the inventory of goods for sale or provides a place for the assembly and consolidation of goods ordered from one or more suppliers 114. In one embodiment, the goods aggregation system 904 includes at least one dedicated supplier storage area 920 that stores inventory for a supplier 114 that is controlled by the suppler 114. In response to an order, the supplier 114 provides instructions to the goods aggregation system 904 to release the ordered goods from the dedicated supplier storage area 920 for packing and possible consolidation with goods from other suppliers 114 and then provided to the delivery system 906. In one embodiment, the distribution system 900 may further comprise a secondary delivery system 802, which may include secondary transport vehicles 803, for delivering goods to secondary delivery sites 804.

FIG. 10 is a flow chart illustrating a method of forming a delivery system and delivery network in accordance with a present invention. The server 210 receives target locations as potential delivery sites 116 for analysis (block 1002). The server 210 may seek the delivery point network 108 by analyzing target locations (block 1004) and adding one of the target locations as a delivery site 116 to the delivery point network 108 (block 1010) in the event that the target location meets certain criteria (block 1008). The target locations may be analyzed by determining the characteristics of people in the vicinity of the target location, such as transit time near the location and the income or purchasing characteristics of a particular class of goods (block 1004). The criteria for adding a target location may be the number of people meeting a certain requirement exceeding a threshold or the collective purchasing characteristics of the group of people at the target location meeting a certain criteria. This process may be repeated for additional target locations with different criteria or requirements (block 1012). For each target location, an agreement with an entity controlling the target location is obtained to authorize placement of the transport vehicles 408 and 803 on the site and the delivery of the ordered goods. In one embodiment, the agreement is an exclusive agreement to preclude other distribution systems to use the target location as a delivery site of purchased goods by the customers 112.

In one embodiment, the selection criteria (block 1006) may relate to market share. For example, the most prominent companies with the largest employee concentrations are selected first in order to gain larger share of the distribution market in a region.

In one set of criteria (block 1006), the pre-arranged delivery sites 116 provide delivery at locations that are convenient to the customers 112. For an employer delivery site 116, the ability to pick up ordered goods nearby as part of the normal process of leaving the office reduces stress, and also collectively reduces pollution and congestion caused by the employees making trips to stores.

The distribution systems 100, 800 and 900 provide a combination of a physical delivery and “new economy” e-commerce. The distribution systems 100, 800 and 900 provide delivery to pre-arranged delivery sites. The customers 112 transverse the “last mile” by traveling to the delivery site to receive the ordered goods. The distribution system 800 further provides a secondary delivery system 802 that provides delivery to customer selected sites such as homes.

In one embodiment, the customer purchases items electronically, and the purchased items are delivered directly to the customer's work place via customized trucks including eighteen-wheel semi-truck trailers. The delivery vehicles are placed in a convenient location, such as a parking lot, at the customer's place of employment during convenient delivery hours such as the end of the work day (e.g., 4:00 P.M.-6:00 P.M.), allowing the customer to walk or drive to the delivery site, give their order number, and receive their pre-paid items. The customer has previously shopped, paid and ordered on-line for their items and is now leaving work for home. Rather than fighting traffic, congestion and frustration to get to a store, the employee merely drives to the delivery site, gives the order number to the attendant who then loads the purchased items into the car for the trip home.

The present invention provides delivering bulk sold goods to the customer's place of employment or other place of convenience at a convenient time and in a convenient manner. The store is brought to the customer, but the customer comes partially to the store to get the purchased goods. Trucks utilizing bulk delivery techniques provide lower distribution costs while providing the old economy “bricks and sticks” element of a physical place to do business. This includes returns, defective merchandise services, and ordering of goods.

In another embodiment, the distribution systems 100, 800, and 900 provide multiple deliveries to the pre-arranged delivery sites. Each delivery may have its own cutoff time for placing an order for the delivery. For example, for a delivery site that is a place of employment, separate deliveries may be made for each shift, and the cutoff time for each shift may be a certain number of hours before the scheduled delivery time, such as the end of each shift. As another example, for a delivery site that is a bus or train station, deliveries may be made throughout a time period for pickup throughout the time period, and the cutoff time for each shift may be a certain number of hours before the scheduled delivery time.

The delivery point networks 108 and 908 are scalable. Additional delivery sites 116 may be added to include locations where large concentrations of commuting or resident populations exit. This means the delivery site 116 could locate a delivery vehicle 408 curbside near a mass-transit entrance during peak commute hours, or in densely packed city housing districts where residents could easily walk outside during convenient delivery hours to pick-up their items. Office buildings with their large population, also may be a delivery site 116. The delivery point network may also include fixed structures and leased space in convenient areas within office buildings, shopping centers, regional malls, gas stations, convenience stores and, in some instances, free standing structures.

In one example of the business to be transacted is the retail grocery business, where a customer who is an employee of a large participating company can access the website listing and displaying available products, while at work or otherwise, place an order, and make payment arrangements, all through the website. By pre-arrangement, all orders placed from that company in a particular time served are processed and delivered to a delivery site 116 at the company, for example, at a point in its parking lot, by a dedicated truck (transport vehicle 408) that is scheduled to be present for a designated period, such as 4:00 P.M. to 7:00 P.M. Thus, each employee can pick up his or her groceries before leaving the company, saving the need for an often time-consuming trek to a market through traffic, parking, aisles and checkout lines.

It will be evident that there are numerous possibilities for various activities in conjunction with the above-described systems and methods. For example, the website is the portal for business with the using consumers, and can be expanded for various categories of goods. The delivery service may be performed by proprietary vehicles, and cooperative ventures may be conducted with other services, such as an office products firm that regularly services the company.

In this disclosure, there is shown and described only the preferred embodiments of the invention, but, as aforementioned, it is to be understood that the invention is capable of use in various other combinations and environments and is capable of changes or modifications within the scope of the inventive concept as expressed herein.

What is claimed is:

1. A distribution method comprising:
receiving orders from ones of a group of purchasers for delivery to a delivery site associated with said group of purchasers during a pre-arranged time period associated with said group of purchasers; and
transporting goods associated with said orders to said delivery site for pick-up by said ones of said group of purchasers.

2. The distribution method of claim 1 wherein the orders are received via the internet.

3. The distribution method of claim 1 wherein the transporting of goods are by dedicated delivery vehicles.

4. The distribution method of claim 3 wherein the orders are received via the internet.

5. The distribution method of claim 1 further comprising transporting goods from the delivery site to a secondary delivery site.

6. The distribution method of claim 1 wherein the pick-up is during a time period that is pre-arranged relative to the delivery site and not pre-arranged by ones of the group of purchasers.

7. A distribution method comprising the steps of:
establishing an interface for the selection and ordering of goods;
establishing at least one selected collective delivery site that is convenient for a particular group of prospective purchasers;
taking orders from members of the group of purchasers for delivery to the delivery site during a pre-arranged time period; and
delivering the orders by dedicated delivery mechanism to the delivery site for pick up by the customers during the pre-arranged time period.

8. The method as defined in claim 7 wherein a plurality of selected delivery points are established by pre-arrangement with a plurality of companies and organizations having numerous members and employees.

9. The method as defined in claim 7 wherein the dedicated delivery mechanism are trucks.

10. The method as defined in claim 7 wherein the goods are groceries.

11. A distribution system comprising:
a delivery site associated with a group of purchasers;
an order center to receive orders from ones of said group of purchasers for delivery to the delivery site during a pre-arranged time period associated with said group of purchasers;
a vehicle to transport goods associated with said orders to said delivery site for pick-up by said ones of said group of purchasers.

12. The distribution system of claim 11 wherein the orders are received via the internet.

13. The distribution system of claim 11 wherein the vehicle is a dedicated delivery vehicle.

14. The distribution system of claim 13 wherein the orders are received via the internet.

15. The distribution system of claim 13 wherein the vehicle includes an identifier of an entity associated with the delivery site.

16. The distribution system of claim 11 further comprising a second vehicle to transport selected ones of said goods from the delivery site to at least one secondary delivery site.

17. The distribution system of claim 11 wherein the pick-up is during a time period that is pre-arranged relative to the delivery site and not pre-arranged by ones of the group of purchasers.

18. A distribution method comprising:
receiving goods associated with orders, said order including a selected pre-arranged delivery point, the pre-arranged delivery point being associated with a customer associated with the order but not pre-arranged by said customer; and
delivering said goods to the pre-arranged delivery point for customer pickup.

19. The distribution method of claim 18 wherein said delivering said goods is during a prearranged time period.

20. The distribution method of claim 19 further comprising receiving return goods at said pre-arranged delivery point during said pre-arranged time period.

21. The distribution method of claim 18 further comprising:
providing to at least one supplier at least one request for said goods in response to said orders.

22. The distribution method of claim 21 wherein said delivering said goods is during a prearranged time period.

23. The distribution method of claim 18 wherein the goods are received from a goods aggregation system.

24. The distribution method of claim 23 wherein said delivering said goods is during a prearranged time period.

25. A delivery system comprising:
at least one transport vehicle to receive goods associated with an order at a first site and to deliver said goods to at least one pre-arranged delivery site for customer pickup, the prearranged delivery site being associated with a customer associated with the order but not prearranged by the customer.

26. The delivery system of claim 25 wherein said at least one transport vehicle is to deliver said goods during a pre-arranged time period.

27. The delivery system of claim 26 further comprising a station to receive return goods at said selected pre-arranged delivery site during said pre-arranged time period.

28. The delivery system of claim 26 further comprising an order interface for receiving an order from a customer at said pre-arranged delivery site during said pre-arranged time period.

29. The delivery system of claim 26 wherein the first site is a goods aggregation system.

30. The delivery system of claim 25 wherein the first site is a goods aggregation system.

31. The delivery system of claim 25 wherein said at least one transport vehicle further comprises an order interface for receiving another order from said customer.

32. The delivery system of claim 31 wherein said at least one transport vehicle is to deliver said goods during a pre-arranged time period.

33. A distribution method comprising:
receiving a plurality of orders, each order indicative of a package of goods associated with a customer;
receiving a plurality of groups of packaged goods, each packaged goods including the goods related to an order, each group including packaged goods having a common pre-arranged destination delivery point for pickup by the customer associated with the order; and
allocating a transport vehicle for each pre-arranged destination delivery point.

34. The distribution method of claim 33 wherein the allocating a transport vehicle includes selecting a transport vehicle from a group of transport vehicles of different storage volumes based on the volume of the groups of packaged goods.

35. A delivery system comprising:
a receiving site to receive a plurality of groups of packaged goods, each packaged goods including the goods related to an order, each order indicative of a package of goods associated with a customer, each group including packaged goods having a common pre-arranged destination delivery site for pickup by the customer associated with the order; and
at least one transport vehicle to deliver to each pre-arranged destination delivery site groups of packaged goods assigned to the at least one transport vehicle.

36. The delivery system of claim 35 wherein a transport vehicle is allocated to deliver ones of said groups based on a storage volume based on a volume of the groups of packaged goods.

37. A method for processing an order for goods, comprising:
receiving an order for purchase of goods from a customer; and
providing order information and destination information to a delivery system, the destination information including a pre-arranged delivery point being associated with a customer associated with the order but not pre-arranged by the customer.

38. The method of claim 37 further comprising providing user interface information for communication with the customer.

39. The method of claim 37 further comprising receiving payment for said order from said customer.

40. An order center for processing an order for goods, comprising:
a communication interface for receiving an order for purchase of goods from a customer; and
an order processor for providing order information and destination information to a delivery system, the destination information including a pre-arranged delivery point being associated with a customer associated with the order but not pre-arranged by the customer.

41. The order center of claim 40 whereas the order processor provides user interface information via the communication interface for communication with the customer.

42. The order center of claim 40 further comprising:
a website manager for providing website information associated with catalog of goods to the customer.

43. A method comprising:
receiving order information and delivery destination information associated with a plurality of customer orders, the delivery destination information includes one of at least one prearranged delivery points associated with a customer associated with the order but not prearranged by the customer;
generating a plurality of packaged goods associated with said order information;
grouping ones of the plurality of packaged goods having a common delivery destination; and
assigning said groups of packaged goods to delivery vehicles based on said common delivery destinations.

44. The method of claim 43 further comprising:
receiving return goods provided to the delivery vehicles at said common delivery destinations; and
processing return goods for shipment to source of return goods or restocking of return goods.

45. The method of claim 43 further comprising:
ordering from at least one supplier goods associated with said plurality of customer orders.

46. The method of claim 45 wherein said receiving order information and said ordering from at least one supplier occur within a 24 hour period, and said assigning said groups of package goods includes assigning said groups of packaged goods to delivery vehicles for delivery to said at least one pre-arranged delivery points during a pre-arranged time period.

47. A goods processing system comprising:
a goods tracking management system to generate packing instructions for a plurality of packaged goods in response to received order information and delivery destination information associated with a plurality of customer orders, the delivery destination information includes one of at least one pre-arranged delivery points associated with a customer associated with the order but not pre-arranged by the customer; and
a goods allocation system for allocating packaged ones of said plurality of packaged goods to groups of packaged goods having a common delivery destination and assigning said groups of packaged goods to delivery vehicles based on said common delivery destinations.

48. The goods processing system of claim 47 further comprising:
a return management system for receiving return goods provided to the delivery vehicles at said common delivery destinations and for processing return goods for shipment to source of return goods or restocking of return goods.

49. The goods processing system of claim 47 wherein the goods tracking management system further generates an order to at least one supplier for goods associated with said plurality of customer orders.

50. The goods processing system of claim 49 wherein the goods tracking management system further receives said order information and provides said order to at least one supplier within a 24 hour period, and said goods allocation system further assigns said groups of packaged goods to said delivery vehicles for delivery to said at least one pre-arranged delivery points during a pre-arranged time period.

51. The goods processing system of claim 47 further comprising at least one dedicated supplier storage area for storing goods associated with a supplier and wherein the goods tracking management system further providing said packaging instructions to include goods from said at least one dedicated supplier storage area in response to order information received from said supplier associated with said dedicated supplier storage area.

52. A method comprising:
analyzing the number of people that transit a target location during a time period;
analyzing purchasing characteristics of said people relative to a class of goods; and
selecting the target location as a delivery site in the event that said number of people exceeds a predetermined threshold and said purchasing characteristics collectively meet a predetermined threshold.

53. A method comprising:
selecting a group of persons having a common characteristic associated with a region during a time interval;
establishing at least one selected delivery point in said region; and
receiving orders for goods from ones of said group of persons for delivery to the delivery site for pickup by said ones of said group of persons during a pre-arranged time period of said time interval.

54. A method for processing an order for goods, comprising:
receiving an order for purchase of goods from a customer; and
providing order information and destination information to a goods aggregation system, the destination information including a pre-arranged delivery point being associated with a customer associated with the order but not pre-arranged by the customer.

55. The method of claim 54 further comprising providing user interface information for communication with the customer.

56. The method of claim 54 further comprising receiving payment for said order from said customer.

57. An order center for processing an order for goods, comprising:
a communication interface for receiving an order for purchase of goods from a customer; and
an order processor for providing order information and destination information to a goods aggregation system, the destination information including a pre-arranged delivery point being associated with a customer associated with the order but not pre-arranged by the customer.

58. The order center of claim 57 whereas the order processor provides user interface information via the communication interface for communication with the customer.

59. The order center of claim 57 further comprising:
a website manager for providing website information associated with catalog of goods to the customer.

60. A distribution method comprising:
receiving orders from ones of a group of purchasers for delivery to a delivery site associated with said group of purchasers and not pre-arranged with said group of purchasers; and
transporting goods associated with said orders to said delivery site for pick-up by said ones of said group of purchasers.

61. A distribution method comprising:
establishing an interface for the selection and ordering of goods;
establishing at least one selected collective delivery point that is convenient for a particular group of prospective purchasers and not pre-arranged with said group of purchasers;
taking orders from members of the group of purchasers for delivery to the delivery site; and
delivering the orders by dedicated delivery mechanism to the delivery site for pick up by the customer.
